(19) United States
(12) Patent Application Publication
(10) Pub. No.: US 2022/0224734 A1
(43) Pub. Date: Jul. 14, 2022

(54) OPTIMIZATION OF NETWORK RESOURCES

(71) Applicant: Telefonaktiebolaget LM Ericsson (publ), Stockholm (SE)

(72) Inventors: Gaurav BHATNAGAR, Delhi (IN); Robert TÖRNKVIST, Karlskrona (SE); Vishal GARG, Faridabad (IN); Mitu VERMA, Noida (IN); Saurabh GUPTA, Etawah (IN)

(73) Assignee: Telefonaktiebolaget LM Ericsson (publ), Stockholm (SE)

(21) Appl. No.: 17/596,427

(22) PCT Filed: Jun. 11, 2019
(86) PCT No.: PCT/SE2019/050548

§ 371 Date: Dec. 10, 2021

(51) Int. Cl. H04L 65/1096; H04L 65/1083

(52) U.S. Cl. CPC H04L 65/1096; H04W 80/10; H04L 65/1083

(57) ABSTRACT

A method for associating partial durations of a voice service session provided via a packet-switched network to parties of the voice service session, wherein the parties comprise a first party and a second party, and wherein dedicated network resources are assigned and/or released intermittently during the voice service session is disclosed. The method comprises invoking, when the voice service session is ongoing, a hold or temporary disconnect of the voice service session by either of the first and second party, storing a Session Description Protocol, (SDP) Offer as negotiated between the first and second party in a storage for a first time duration, and associating, to the party who invoked the hold or temporary disconnect of the voice service session, an intermediate partial duration of the voice service session that starts when the hold or temporary disconnect of the voice service session was invoked.

### TECHNICAL FIELD

The present disclosure relates generally to the field of optimizing network resources. More particularly, it relates to optimizing network resources for voice service sessions provided via a packet-switched network.

### BACKGROUND

A voice service session may be provided via a packet-switched network over e.g. Voice over Long Term Evolution, LTE, and/or Voice over 5G. During the voice service session network resources may be assigned and/or released intermittently by e.g. putting the voice service session on hold or temporarily disconnecting by at least one party of the voice service session.

A drawback of assigning and/or releasing network resources intermittently during the voice service session is that network resources are not optimally utilized during the voice service session due to the intermittency.

Another drawback of assigning and/or releasing network resources intermittently during the voice service session is that a significant energy usage is required for the intermittent assigning and/or releasing of network resources during the voice service session.

Therefore, there is a need for alternative approaches for optimizing network resources for voice service sessions provided via a packet-switched network.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise. Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

According to a first aspect, this is achieved by a method for associating partial durations of a voice service session provided via a packet-switched network to parties of the voice service session, wherein the parties comprise a first party and a second party, and wherein dedicated network resources are assigned and/or released intermittently during the voice service session.

The method comprises invoking, when the voice service session is ongoing, a hold or temporary disconnect of the voice service session by either of the first and second party and storing a Session Description Protocol (SDP) Offer as negotiated between the first and second party in a storage for a first time duration.

The method further comprises associating, to the party who invoked the hold or temporary disconnect of the voice service session, an intermediate partial duration of the voice service session that starts when the hold or temporary disconnect of the voice service session was invoked.

In some embodiments, the method further comprises initiating, by a first party, via a Session Initiation Protocol, SIP, invite message comprising a SDP Offer, a voice service session with a second party and establishing, by the second party, the voice service session in response to the SIP invite message so that voice traffic can flow through the dedicated network resources, and associating, to the first party, a first partial duration of the voice service session that starts when the voice service session was initiated.

In some embodiments, the method further comprises resuming the voice service session by the party who invoked the hold or the temporary disconnect of the voice service session, retrieving the stored SDP offer from the storage, and associating, to the first party, a second partial duration of the voice service session from the time when the voice service session was resumed.

In some embodiments, the method further comprises releasing the dedicated network resources of the voice service session in response to the storing of the SDP offer, and re-assigning the dedicated network resources for the voice service session in response to the retrieval of the stored SDP offer.

In some embodiments, the method further comprises discarding a Real-time Transport Protocol (RTP) session when the dedicated network resources of the voice service session are released, and establishing the RTP session using the retrieved SDP offer when the dedicated network resources of the resumed voice service session are re-assigned.

In some embodiments, the RTP session comprises a media bearer for the voice service session.

In some embodiments, the method further comprises replacing the first time duration in the stored SDP offer with a second time duration when the first time duration has expired and the voice service session is on hold or in temporary disconnect.

In some embodiments, the method further comprises discarding the stored SDP offer when the first time duration expires or when the voice service session is terminated before the expiry of the first time duration.

In some embodiments, the first time duration comprises a Time to Live, TTL, value.

In some embodiments, the second time duration comprises an enhanced TTL value.

In some embodiments, the Session Initiation Protocol, SIP, invite message further comprises a call-back token.

In some embodiments, the call-back token comprises information for resuming the voice service session by the party who invoked the hold or the temporary disconnect.

In some embodiments, the SDP offer comprises negotiated and selected codecs, media streams, IP addresses and ports for the voice service session.

In some embodiments, the storage comprises a Home Subscriber Service, HSS and/or a Unified Data Management, UDM.

In some embodiments, the voice service session is provided over Voice over Long Term Evolution, LTE, and/or Voice over 5G via the packet-switched network.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus configured for association of partial durations of a voice service session provided via a packet-switched network to parties of the voice service session, wherein the parties comprise a first party and a second party, and wherein dedicated network resources are assigned and/or released intermittently during the voice service session.

The apparatus comprises controlling circuitry configured to cause reception, when the voice service session is ongoing, of a signal for invoking a hold or temporary disconnect of the voice service session from either of the first and second party and storing of a SDP Offer as negotiated between the first and second party in a storage for a first time duration.

The controlling circuitry is further configured to cause association, to the party who invoked the hold or temporary disconnect of the voice service session, of an intermediate partial duration of the voice service session that starts when the hold or temporary disconnect of the voice service session was invoked.

In some embodiments, the controlling circuitry is further configured to cause reception of a Session Initiation Protocol, SIP, invite message comprising a SDP Offer, a voice service session from a first party, establishment of the voice service session in response to the SIP invite message so that voice traffic can flow through the dedicated network resources, and association, to the first party, of a first partial duration of the voice service session that starts when the voice service session was initiated.

In some embodiments, the controlling circuitry is further configured to cause reception, when the voice service session is on hold or on temporary disconnect, of a signal for resuming of the voice service session from the party who invoked the hold or the temporary disconnect of the voice service session, retrieval of the stored SDP offer from the internal storage, and association, to the first party, of a second partial duration of the voice service session from the time when the voice service session was resumed.

In some embodiments, the controlling circuitry is further configured to cause release of the dedicated network resources of the voice service session in response to the storing of the SDP offer, and re-assignment of the dedicated network resources for the voice service session in response to the retrieval of the stored SDP offer.

In some embodiments, the controlling circuitry is further configured to cause discard of a RTP session when the dedicated network resources of the voice service session are released, and establishment of the RTP session using the retrieved SDP offer when the dedicated network resources of the resumed voice service session are re-assigned.

In some embodiments, the RTP session comprises a media bearer for the voice service session.

In some embodiments, the controlling circuitry is further configured to cause replacement of the first time duration in the stored SDP offer with a second time duration when the first time duration has expired and the voice service session is on hold or in temporary disconnect.

In some embodiments, the controlling circuitry is further configured to cause of the stored SDP offer when the first time duration expires or when the voice service session is terminated before the expiry of the first time duration.

In some embodiments, the first time duration comprises a Time to Live, TTL, value.

In some embodiments, the second time duration comprises an enhanced TTL value.

In some embodiments, the Session Initiation Protocol, SIP, invite message further comprises a call-back token.

In some embodiments, the call-back token comprises information for resuming the voice service session by the party who invoked the hold or the temporary disconnect.

In some embodiments, the SDP offer comprises negotiated and selected codecs, media streams, IP addresses and ports for the voice service session.

In some embodiments, the storage comprises a Home Subscriber Service, HSS and/or a Unified Data Management, UDM.

In some embodiments, the voice service session is provided over Voice over Long Term Evolution, LTE, and/or Voice over 5G via the packet-switched network.

An advantage of some embodiments is that alternative approaches for optimizing network resources for voice service sessions provided via a packet-switched network are provided.

Another advantage of some embodiments is that network resources may be dynamically utilized during voice service sessions as the network resources are intermittently assigned and/or released during the voice service session i.e. the network resources are not seized for the total duration of the voice service session in case of intermittency during the voice service session resulting in more efficient network resource utilization.

Yet an advantage of some embodiments is that the energy usage may be decreased during voice service sessions both for the network wherein the network resources may be dynamically utilized during voice service sessions as the network resources are intermittently assigned and/or released during the voice service session and for the user equipments of the parties of the voice service session.

Yet another advantage of some embodiments is that adaptive charging for voice service sessions may be realized as an association of a partial duration of the voice service session to a certain party may provide basis for adaptive charging, i.e. charging according to the associated partial durations of the voice service session, to either the first party, the second party or a third party e.g. a network operator.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a sequence diagram illustrating example signaling steps according to some embodiments,

FIG. 3a is a sequence diagram illustrating example signaling steps according to some embodiments,

FIG. 3b is a sequence diagram illustrating example signaling steps according to some embodiments,

FIG. 3c is a sequence diagram illustrating example signaling steps according to some embodiments,

FIG. 4 is a schematic block diagram illustrating an example apparatus according to some embodiments; and

FIG. 5 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, voice service session may be provided via a packet-switched network over e.g. Voice over Long Term Evolution, LTE, and/or Voice over 5G. During the voice service session network resources may be assigned and/or released intermittently by e.g. putting the voice service session on hold or temporarily disconnecting it by at least one party of the voice service session.

An example of a voice service session via a packet-switched network over Voice over LTE, VoLTE and/or Voice over 5G, Vo5G could comprise a voice service session of a total duration of 60 seconds of which a first party, i.e. a calling party, is in conversation with a second party, i.e. a called party for a period of e.g. 12 seconds whereby the second party puts the voice service session on hold or temporary disconnect for a period of e.g. 40 seconds and then the second party resumes the voice service session and continues the conversation with the first party for another period of 8 seconds.

During this example voice service session of 60 seconds the network resources have been assigned and/or released intermittently resulting in a non-optimal network resource usage as the network resources are seized for the total duration of the voice service session (i.e. 60 seconds) even though the network resources were not utilized during the on hold or temporary disconnect period (i.e. 40 seconds) resulting in excessive energy consumption for both network and user equipments. Further, the first party has been charged for the total duration of 60 seconds including the time when the voice service session was on hold or temporary disconnect.

Current protocols and standards relating to 4G (LTE) and/or 5G, e.g. Third Generation Partnership Project (3GPP) Technical Specification (TS) 24.610, 3GPP TS 24.229, 3GPP TS 32.240, 3GPP TS 32.290, 3GPP TS 32.291, 3GPP TS 32.299, do not provide any mechanism to overcome above-mentioned drawbacks.

In the following, embodiments where alternative approaches for optimizing network resources for voice service sessions provided via a packet-switched network are described.

Voice service sessions may comprise voice services delivered via a packet-switched network. Hereinafter only the term voice service session will be used for consistency.

Network resources may comprise shared resources in a packet-switched network. Hereinafter only the term network resources will be used for consistency.

Intermittently may comprise alternately ceasing and followed by releasing irregularly. Hereinafter only the term intermittently will be used for consistency.

Associating durations of a voice service session may comprise assigning/linking/coupling a time duration of a voice service session to a certain party e.g. to a user equipment belonging to a party. Hereinafter only the term associating will be used for consistency.

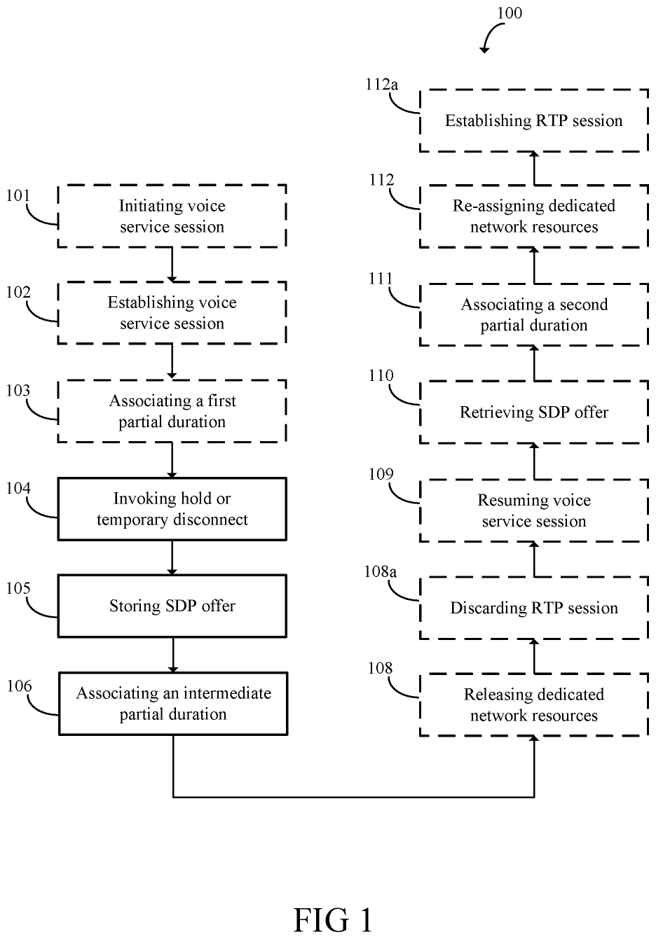

FIG. 1 is a flowchart illustrating method steps of an example method 100 according to some embodiments. The method 100 is for associating partial durations of a voice service session provided via a packet-switched network to parties of the voice service session, wherein the parties comprise a first party and a second party, and wherein dedicated network resources are assigned and/or released intermittently during the voice service session.

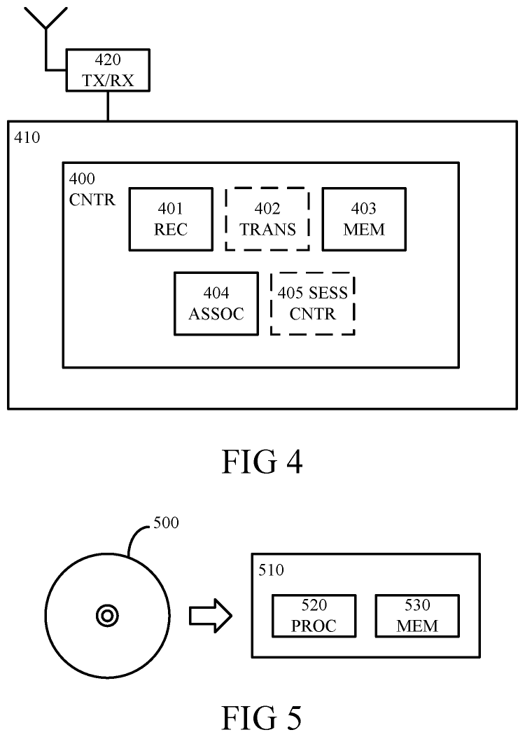

Thus, the method 100 may, for example, be performed by the apparatus 400 of FIG. 4 and/or the computer program product 500 of FIG. 5.

The method 100 comprises following steps.

In step 101, in some embodiments, a voice service session is initiated, by a first party, via a Session Initiation Protocol, SIP, invite message comprising a SDP Offer, with a second party.

In step 102, in some embodiments, the voice service session is established, by the second party, in response to the SIP invite message so that voice traffic can flow through the dedicated network resources.

In step 103, in some embodiments, a first partial duration of the voice service session that starts when the voice service session was initiated and ends when an intermediate partial duration starts is associated to the first party. This enables the first party to be adaptively charged for the first partial duration of the voice service session.

In step 104, a hold or temporary disconnect of the voice service session is invoked by either of the first and second party when the voice service session is ongoing.

In step 105, a SDP Offer as negotiated between the first and second party is stored in a storage for a first time duration.

In step 106, an intermediate partial duration of the voice service session that starts when the hold or temporary disconnect of the voice service session was invoked and ends according to different alternatives, e.g. when a second partial duration starts or when the voice service session is terminated, is associated to the party who invoked the hold or temporary disconnect of the voice service session. This enables the party who invoked the hold or temporary disconnect to be adaptively charged for the intermediate partial duration of the voice service session.

In step 107a (not shown), in some embodiments, the first time duration in the stored SDP offer is replaced with a second time duration when the first time duration has expired and the voice service session is on hold or in temporary disconnect so that the stored SDP offer is maintained in the storage for as long as the voice service session is on hold or in temporary disconnect.

In step 107b (not shown), in some embodiments, the stored SDP offer is discarded when the first time duration expires or the voice service session is terminated before the expiry of the first time duration.

In step 108, in some embodiments, the dedicated network resources of the voice service session are released in response to the storing of the SDP offer.

In step 108a, in some embodiments, a RTP session is discarded when the dedicated network resources of the voice service session are released.

In step 109, in some embodiments, the voice service session is resumed by the party who invoked the hold or the temporary disconnect of the voice service session.

In step 110, in some embodiments, the stored SDP offer is retrieved from the storage.

In step 111, in some embodiments, a second partial duration of the voice service session that starts when the voice service session was resumed and ends according to different alternatives, e.g. when another intermediate partial duration starts or when the voice service session is terminated, is associated to the first party. This enables the first party to be adaptively charged for the second partial duration of the voice service session.

In step 112, in some embodiments, the dedicated network resources for the voice service session are re-assigned in response to the retrieval of the stored SDP offer.

In step 112a, in some embodiments, the RTP session is established using the retrieved SDP offer when the dedicated network resources of the resumed voice service session are re-assigned.

Above method steps may be iterated until the voice service session is terminated.

An advantage of some embodiments is that alternative approaches for optimizing network resources for voice service sessions provided via a packet-switched network are provided.

Another advantage of some embodiments is that network resources may be dynamically utilized during voice service sessions as the network resources are intermittently assigned and/or released during the voice service session i.e. the network resources are not seized for the total duration of the voice service session in case of intermittency during the voice service session resulting in more efficient network resource utilization.

Yet an advantage of some embodiments is that the energy usage may be decreased during voice service sessions both for the network wherein the network resources may be dynamically utilized during voice service sessions as the network resources are intermittently assigned and/or released during the voice service session and for the user equipments of the parties of the voice service session.

Yet another advantage of some embodiments is that adaptive charging for voice service sessions may be realized as an association of a partial duration of the voice service session to a certain party may provide basis for adaptive charging, i.e. charging according to the associated partial durations of the voice service session, to either the first party, the second party or a third party e.g. a network operator.

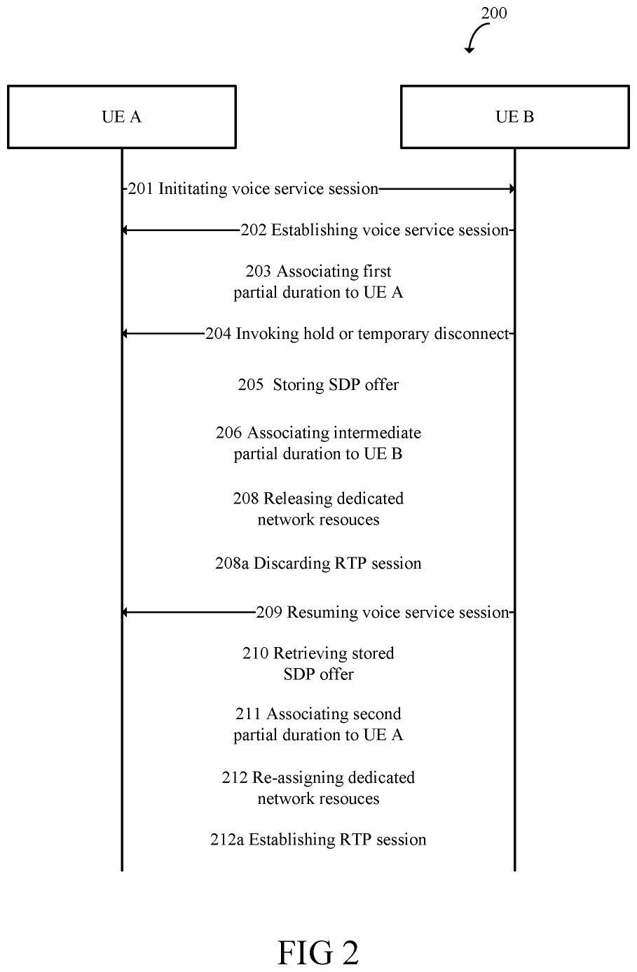

FIG. 2 is a sequence diagram illustrating signaling steps of an example signaling 200 according to some embodiments. The signaling 200 is for associating partial durations of a voice service session provided via a packet-switched network to parties of the voice service session, wherein the parties comprise a first party and a second party, and wherein dedicated network resources are assigned and/or released intermittently during the voice service session. Thus, the signaling 200 may, for example, be performed by the apparatus 400 of FIG. 4 and/or the computer program product 500 of FIG. 5.

The signaling 200 comprises following steps.

In step 201, corresponding to step 101 of the method 100 illustrated in FIG. 1, a voice service session is initiated, by a first party UE A, via a Session Initiation Protocol, SIP, invite message comprising a SDP Offer, with a second party UE B.

In step 202, corresponding to step 102 of the method 100 illustrated in FIG. 1, the voice service session is established, by the second party UE B, in response to the SIP invite message so that voice traffic can flow through the dedicated network resources.

In step 203, corresponding to step 103 of the method 100 illustrated in FIG. 1, a first partial duration of the voice service session that starts when the voice service session was initiated is associated to the first party UE A.

In step 204, corresponding to step 104 of the method 100 illustrated in FIG. 1, a hold or temporary disconnect of the voice service session is invoked by the second party UE B when the voice service session is ongoing.

In step 205, corresponding to step 105 of the method 100 illustrated in FIG. 1, a SDP Offer as negotiated between the first UE A and second party UE B is stored in a storage for a first time duration.

In step 206, corresponding to step 106 of the method 100 illustrated in FIG. 1, an intermediate partial duration of the voice service session that starts when the hold or temporary disconnect of the voice service session was invoked is associated to the party UE B who invoked the hold or temporary disconnect of the voice service session.

In step 208, corresponding to step 108 of the method 100 illustrated in FIG. 1, the dedicated network resources of the voice service session are released in response to the storing of the SDP offer.

In step 208a, corresponding to step 108a of the method 100 illustrated in FIG. 1, a RTP session is discarded when the dedicated network resources of the voice service session are released.

In step 209, corresponding to step 109 of the method 100 illustrated in FIG. 1, the voice service session is resumed by the party UE B who invoked the hold or the temporary disconnect of the voice service session.

In step 210, corresponding to step 110 of the method 100 illustrated in FIG. 1, the stored SDP offer is retrieved from the storage.

In step 211, corresponding to step 111 of the method 100 illustrated in FIG. 1, a second partial duration of the voice service session that starts when the voice service session was resumed is associated to the first party UE A.

In step 212, corresponding to step 112 of the method 100 illustrated in FIG. 1, the dedicated network resources for the voice service session are re-assigned in response to the retrieval of the stored SDP offer.

In step 212a, corresponding to step 112a of the method 100 illustrated in FIG. 1, the RTP session is established using the retrieved SDP offer when the dedicated network resources of the resumed voice service session are re-assigned.

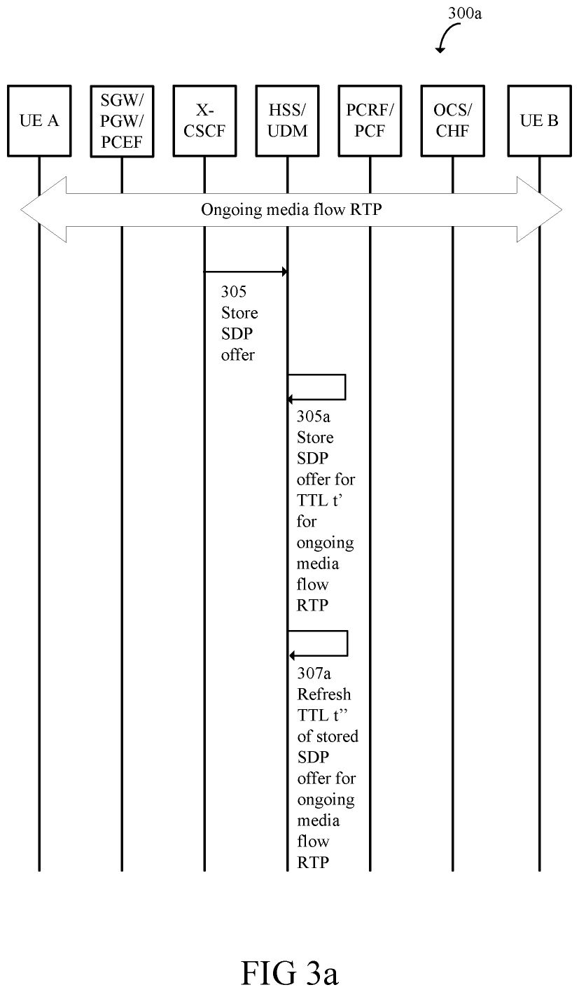

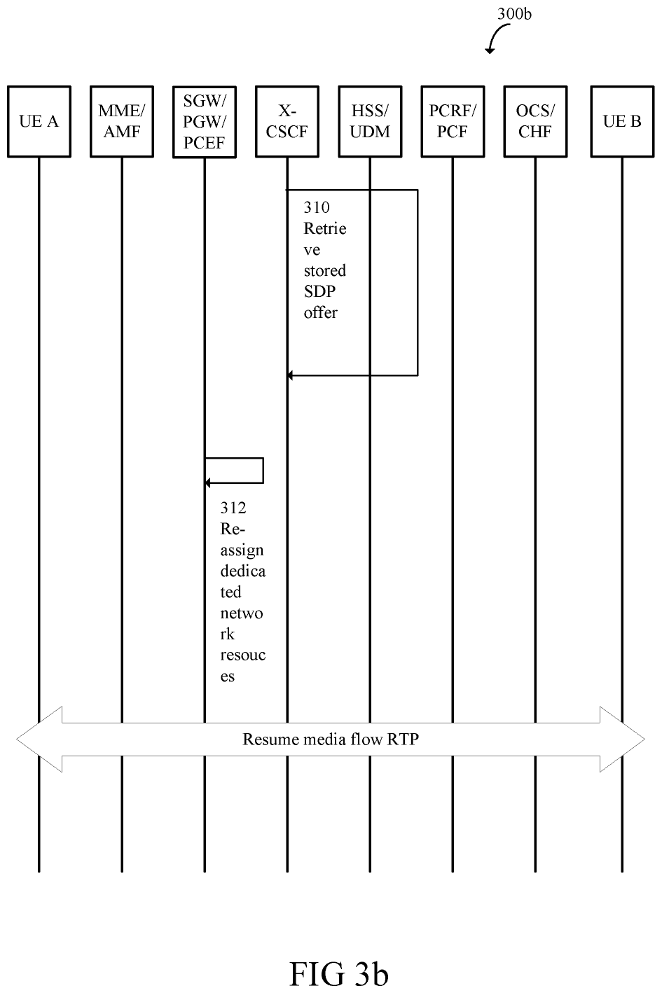

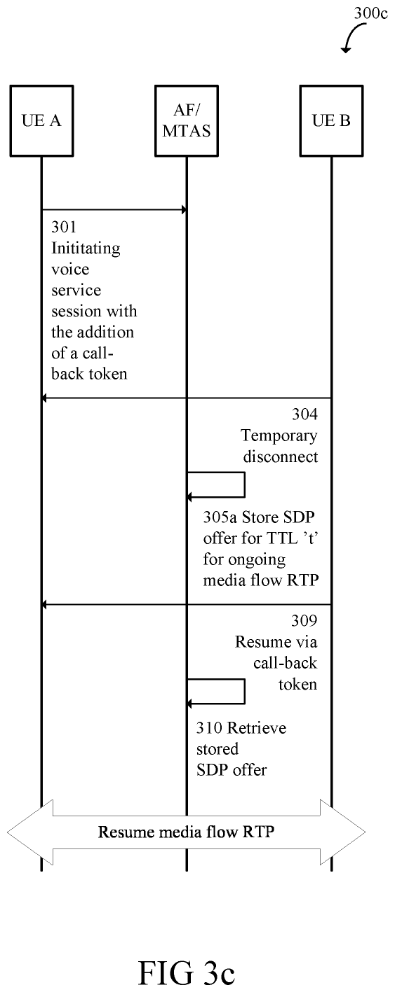

FIG. 3a is a sequence diagram illustrating signaling steps of an example signaling 300a according to some embodiments. The signaling 300a is for associating partial durations of a voice service session provided via a packet-switched network to parties of the voice service session, wherein the parties comprise a first party and a second party, and wherein dedicated network resources are assigned and/or released intermittently during the voice service session. Thus, the signaling 300a may, for example, be performed by the apparatus 400 of FIG. 4 and/or the computer program product 500 of FIG. 5.

FIG. 3a illustrates an ongoing media flow RTP session comprising e.g. a voice service session, after a successful SIP call setup of which details are specified in 3GPP TS 24.229 which describes an IMS call control protocol based on SIP and SDP protocols.

The entities Serving Gateway (SGW)/Packet Data Network Gateway (PGW)/Policy and Charging Enforcement Function (PCEF); Interrogating/Proxy/Serving Call Session Control Function (X-CSCF); Home Subscribe Server (HSS)/Unified Data Management (UDM); Policy and Charging Rules Function (PCRF)/Policy Control Function (PCF); Online Charging System (OCS)/Charging Function (CHF) illustrated in FIG. 3a are described and specified in 3GPP TS 24.229, 3GPP TS 29.211, 3GPP TS 29.212, and 3GPP TS 24.610.

FIG. 3a further illustrates a non-roaming scenario for VoLTE and/or Vo5G wherein UE A is a calling party and UE B is a called party.

In step 305, corresponding to step 105 of the method 100 illustrated in FIG. 1 and step 205 of the signaling 200 illustrated in FIG. 2, a SDP Offer as negotiated between the calling party UE A and called party UE B is stored in a storage, Home Subscribe Server/Unified Data Management, HSS/UDM, for a first time duration.

In step 305a, the SDP offer as negotiated between the calling party UE A and called party UE B is stored in HSS/UDM for a first time duration Time to Live, TTL, t′, for the ongoing media flow RTP session.

In step 307a, corresponding to step 107a of the method 100 illustrated in FIG. 1, the first time duration in the stored SDP offer is replaced with a second time duration enhanced TTL, t″, when the first time duration t′ has expired and the voice service session is on hold or in temporary disconnect.

FIG. 3b is a sequence diagram illustrating signaling steps of an example signaling 300b according to some embodiments. The signaling 300b is for associating partial durations of a voice service session provided via a packet-switched network to parties of the voice service session, wherein the parties comprise a first party and a second party, and wherein dedicated network resources are assigned and/or released intermittently during the voice service session. Thus, the signaling 300b may, for example, be performed by the apparatus 400 of FIG. 4 and/or the computer program product 500 of FIG. 5.

FIG. 3b illustrates a resumed media flow RTP session comprising e.g. a voice service session, of which details are specified in 3GPP TS 24.229 which describes HOLD using IP Multimedia Core Network subsystem.

The entities Mobile Management Entity (MME)/Access Management Function (AMF); SGW/PGW/PCEF; X-CSCF; HSS/UDM; PCRF/PCF; OCS/CHF illustrated in FIG. 3b are described and specified in 3GPP TS 24.229, 3GPP TS 29.211, 3GPP TS 29.212, 3GPP TS 24.610, 3GPP TS 32.240, 3GPP TS 32.260, 3GPP TS 32.299, 3GPP TS 32.290, and 3GPP TS 32.291.

FIG. 3b further illustrates a non-roaming scenario for VoLTE and/or Vo5G wherein UE A is a calling party and UE B is a called party.

In step 310, corresponding to step 110 of the method 100 illustrated in FIG. 1 and step 210 of the signaling 200 illustrated in FIG. 2, the stored SDP offer is retrieved from the storage HSS/UDM.

In step 312, corresponding to step 112 of the method 100 illustrated in FIG. 1 and step 212 of the signaling 200 illustrated in FIG. 2, the dedicated network resources for the voice service session are re-assigned in response to the retrieval of the stored SDP offer.

After completing step 312, the media flow RTP session comprising e.g. a voice service session is resumed.

An example of the method steps described in connection with FIG. 1 and/or the signaling steps described in connection with FIGS. 2 and 3a-3b may comprise following:
UE A, the calling party, and UE B, the called party, are parties in a voice service session provided via a packet-switched network over VoLTE and/or Vo5G. It is assumed that both parties have enough balance to participate in the voice service session.
After some time, UE B invokes a call hold. It is further assumed that UE A has opted for adaptive charging.
By using adaptive charging either parties or both or none can be charged for intermittent durations within the same voice service session.
UE A, the calling party, is charged for the time duration as the voice service session progresses until UE B puts the voice service session on hold. During the “on hold”, i.e. call hold, time duration, UE B is charged. As soon as the voice service session is resumed by UE B, charging of UE A is resumed and charging of UE B is stopped. There may be multiple call holds within a same voice service session and for each “on hold” time duration this process is repeated.
As soon as the ongoing voice service session goes “on hold”, the last negotiated SDP offer is stored in HSS or UDM for later retrieval.
Current RTP session between UE A and UE B is scraped and media bearer is released.
When the voice call resumes after a call hold, previously stored SDP offer is retrieved from HSS or UDM.
RTP session is again established between UE A and UE B using the retrieved SDP offer.
If voice service session hold continues, the TTL value of the stored last negotiated SDP offer is updated by an enhanced TTL value.
Charging of UE B continues and charging of UE A remains on hold until UE B resumes the voice service session.
Charging for UE B is optional and the network operator may configure UE B to not be charged for the “on hold” time duration instead a third party may be charged for the “on hold” time duration e.g. the network operator itself.
During the “on hold” time duration, the RTP session is scraped and is setup again when the voice service session resumes using the last negotiated SDP offer.
If anytime during the voice service session the voice service session gets dropped the stored negotiated SDP offer stored on HSS or UDM is garbage collected as soon as the TTL value expires. Also negotiated SDP offer is garbage collected after termination of the voice service session.
It is always possible to fall back to the normal “on hold” in which no RTP session is scraped.
The control signaling for the voice service session will not be terminated by UE A and UE B even if the media bearer is scraped during the “on hold” duration.
Charging of UE A and/or UE B is always possible as both parties are always provisioned in their respective OCS/CHF.
   OCS/CHF can be common or different for UE A and UE B.

For voice service sessions comprising durations of “on hold” of longer time duration i.e. “on hold” time duration of more than a given threshold, e.g. for voice service session with a call centre, the method described in above example would be very useful.

FIG. 3c is a sequence diagram illustrating signaling steps of an example signaling 300c according to some embodiments. The signaling 300c is for associating partial durations of a voice service session provided via a packet-switched network to parties of the voice service session, wherein the parties comprise a first party and a second party, and wherein dedicated network resources are assigned and/or released intermittently during the voice service session. Thus, the signaling 300c may, for example, be performed by the apparatus 400 of FIG. 4 and/or the computer program product 500 of FIG. 5.

The entity (Application Function) AF/Multimedia Telephony Application Server (MTAS) illustrated in FIG. 3a is specified and described in 3GPP TS 24.229, 3GPP TS 29.211 and 3GPP TS 29.212.

FIG. 3c further illustrates a non-roaming scenario for VoLTE and/or Vo5G wherein UE A is a calling party and UE B is a called party.

In step 301, corresponding to step 101 of the method 100 illustrated in FIG. 1 and step 201 of the signaling 200 illustrated in FIG. 2, a voice service session is initiated, by a first party UE A, via a Session Initiation Protocol, SIP, invite message comprising a SDP Offer, with a second party UE B. The invite message further comprising a call-back token for resuming the voice service session at a possible temporary disconnect.

In step 304, corresponding to step 104 of the method 100 illustrated in FIG. 1 and step 204 of the signaling 200 illustrated in FIG. 2, a temporary disconnect of the voice service session is invoked by the second party UE B when the voice service session is ongoing.

In step 305a, corresponding to step 305a of the signaling 300a illustrated in FIG. 3a, the SDP offer as negotiated between the calling party UE A and called party UE B is stored in HSS/UDM for a first time duration Time to Live, TTL, t′, for the ongoing media flow RTP session.

In step 309, corresponding to step 109 of the method 100 illustrated in FIG. 1 and step 209 of the signaling 200 illustrated in FIG. 2, the voice service session is resumed by the party UE B who invoked the temporary disconnect of the voice service session.

In step 310, corresponding to step 110 of the method 100 illustrated in FIG. 1 and step 210 of the signaling 200 illustrated in FIG. 2, the stored SDP offer is retrieved from the storage AF/MTAS.

In some embodiments, the storage may also comprise HSS/UDM or any other storage suitable for storing and retrieving the SDP offer.

After completing step 310, the media flow RTP session comprising e.g. a voice service session is resumed.

An example of the method steps described in connection with FIG. 1 and/or the signaling steps described in connection with FIGS. 2 and 3a-3c may comprise following:

Assumption: UE A is subscribed with “Automated Call-back” service provided by the network operator.
UE A initiates a voice service session with UE B via an invite message comprising a call-back token for resuming the voice service session at a possible temporary disconnect. Alternatively, the call-back token may also be provided during the voice service session but before any temporary disconnect.
UE B temporary disconnects from the voice service session.
UE B, once available again, resumes the voice service session by sending a link, possibly comprising the call-back token, to a call-back service hosted in the network. The link may be a onetime link.
The call-back service connects UE A and UE B for the voice service session, for UE B it may be using the link shared by UE B.

UE A is charged for the connecting from the call-back service since UE A has the subscription for the “Automated Call-back” service.

For voice service sessions comprising a temporary disconnect wherein UE B disconnects from the voice service session for a duration of time, the method described in above example would be very useful in order to resume voice service session again between UE A and UE B which may e.g. be a certain person in a call centre

FIG. 4 is a schematic block diagram illustrating an example apparatus according to some embodiments. The example apparatus is an apparatus 410 for associating partial durations of a voice service session provided via a packet-switched network to parties of the voice service session, wherein the parties comprise a first party and a second party, and wherein dedicated network resources are assigned and/or released intermittently during the voice service session.

Thus, the apparatus 410 may, for example, perform the method steps described in connection with FIG. 1 and signaling steps described in connection with FIG. 2 and FIGS. 3a-c or otherwise described herein.

The apparatus 410 comprises device controlling circuitry (CNTR) 400, which may in turn comprise a receiving module (REC) 401, e.g. receiving circuitry, configured to receive, when the voice service session is ongoing, a signal for invoking a hold or temporary disconnect of the voice service session from either of the first and second party, a storing module (MEM) 403, e.g. memory circuitry, configured to store a SDP Offer as negotiated between the first and second party in a storage for a first time duration, and an associating module (ASSOC) 404, e.g. associating circuitry, configured to associate, to the party who invoked the hold or temporary disconnect of the voice service session, an intermediate partial duration of the voice service session that starts when the hold or temporary disconnect of the voice service session was invoked.

The ASSOC 404 may be further configured to associate, to the first party, a first partial duration of the voice service session that starts when the voice service session was initiated and ends when the intermediate partial duration of the voice service session starts.

The ASSOC 404 may be furthermore configured to associate, to the first party, a second partial duration of the voice service session that starts when the voice service session was resumed and ends according to different alternatives, e.g. when another intermediate partial duration starts or when the voice service session is terminated.

The CNTR 400 may further comprise a transmitting module (TRANS) 402, e.g. transmitting circuitry, configured to transmit a call-back token of a voice service sessions for resuming the voice service session at a possible temporary disconnect to a call-back service hosted in the network. The call-back token may be further stored in MEM 403.

The CNTR may further comprise a session controller module (SESS CNTR) 405, e.g. session controlling circuitry, configured to control a voice service session according to the method steps described in connection with FIG. 1 and signaling steps described in connection with FIG. 2 and FIGS. 3a-c or otherwise described herein.

The apparatus 410 may further comprise a transceiving module (TX/RX) 420, e.g. transceiving circuitry, configured to transceive i.e. transmit and/or receive packet data of voice service sessions over a wireless communication network e.g. LTE and/or 5G.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM). FIG. 5 illustrates an example computer readable medium in the form of a compact disc (CD) ROM 500. The computer readable medium has stored thereon a computer program comprising program instructions. The computer program is loadable into a data processor (PROC) 520, which may, for example, be comprised in a wireless communication device 510. When loaded into the data processing unit, the computer program may be stored in a memory (MEM) 530 associated with or comprised in the data-processing unit. According to some embodiments, the computer program may, when loaded into and run by the data processing unit, cause execution of method steps according to, for example, any of the method illustrated in FIG. 1 or signaling steps according to, for example, any of the signaling illustrated in FIGS. 2 and 3a-c or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for associating partial durations of a voice service session provided via a packet-switched network to parties of the voice service session, wherein the parties comprise a first party and a second party, and wherein dedicated network resources are assigned, released, or both assigned and released, intermittently during the voice service session, the method comprising:
invoking, when the voice service session is ongoing, a hold or temporary disconnect of the voice service session by either of the first and second party;
storing a Session Description Protocol (SDP) Offer as negotiated between the first and second party in a storage for a first time duration; and
associating, to the party who invoked the hold or temporary disconnect of the voice service session, an intermediate partial duration of the voice service session that starts when the hold or temporary disconnect of the voice service session was invoked.

2. The method according to claim 1, further comprising:
initiating, by a first party via a Session Initiation Protocol (SIP) invite message comprising a SDP Offer, a voice service session with a second party;
establishing, by the second party, the voice service session in response to the SIP invite message so that voice traffic can flow through the dedicated network resources; and
associating, to the first party, a first partial duration of the voice service session that starts when the voice service session was initiated.

3. The method according to claim 1, further comprising:
resuming the voice service session by the party who invoked the hold or the temporary disconnect of the voice service session;
retrieving the stored SDP offer from the storage; and
associating, to the first party, a second partial duration of the voice service session that starts when the voice service session was resumed.

4. The method according to claim 1, further comprising:
releasing the dedicated network resources of the voice service session in response to the storing of the SDP offer; and
re-assigning the dedicated network resources for the voice service session in response to a retrieval of the stored SDP offer.

5. The method according to claim 4, further comprising:
discarding a Real-time Transport Protocol (RTP) session when the dedicated network resources of the voice service session are released; and
establishing the RTP session using the retrieved SDP offer when the dedicated network resources of the resumed voice service session are re-assigned.

6. The method according to claim 5, wherein the RTP session comprises a media bearer for the voice service session.

7. The method according to claim 1, further comprising:
replacing the first time duration in the stored SDP offer with a second time duration when the first time duration has expired and the voice service session is on hold or in temporary disconnect.

8. The method according to claim 7, further comprising:
discarding the stored SDP offer when the first time duration expires or when the voice service session is terminated before the expiry of the first time duration.

9. The method according to claim 8, wherein the first time duration comprises a Time to Live (TTL) value.

10. The method according to claim 9, wherein the second time duration comprises an enhanced TTL value.

11. The method according to claim 2, wherein the SIP invite message further comprises a call-back token.

12. The method according to claim 11, wherein the call-back token comprises information for resuming the voice service session by the party who invoked the hold or the temporary disconnect.

13. The method according to claim 1, wherein the SDP offer comprises negotiated and selected codecs, media streams, IP addresses and ports for the voice service session.

14. The method according to claim 1, wherein the storage comprises a Home Subscriber Service (HSS), a Unified Data Management (UDM), or both HSS and UDM.

15. The method according to claim 1, wherein the voice service session is provided over Voice over Long Term Evolution (LTE), Voice over 5G, or both Voice over LTE and Voice over 5G, via the packet-switched network.

16. A non-transitory computer readable storage medium, having thereon a computer program comprising program instructions which, when executed by a processing unit, cause association of partial durations of a voice service session provided via a packet-switched network to parties of the voice service session, wherein the parties comprise a first party and a second party, and wherein dedicated network resources are assigned, released, or both assigned and released, intermittently during the voice service session, by performing operations comprising:
invoking, when the voice service session is ongoing, a hold or temporary disconnect of the voice service session by either of the first and second party;
storing a Session Description Protocol (SDP) Offer as negotiated between the first and second party in a storage for a first time duration; and
associating, to the party who invoked the hold or temporary disconnect of the voice service session, an intermediate partial duration of the voice service session that starts when the hold or temporary disconnect of the voice service session was invoked.

17. An apparatus configured for association of partial durations of a voice service session provided via a packet-switched network to parties of the voice service session, wherein the parties comprise a first party and a second party, and wherein dedicated network resources are assigned released, or both assigned and released, intermittently during the voice service session, the apparatus comprising:
a processing unit; and
a memory comprising program instructions which, when executed by the processing unit, cause the apparatus to perform operations to cause:
reception, when the voice service session is ongoing, of a signal for invoking a hold or temporary disconnect of the voice service session from either of the first and second party;
store of a Session Description Protocol (SDP) Offer as negotiated between the first and second party in a storage for a first time duration; and
association, to the party who invoked the hold or temporary disconnect of the voice service session, of an intermediate partial duration of the voice service session that starts when the hold or temporary disconnect of the voice service session was invoked.

18. The apparatus according to claim 17 further to cause:
reception of a Session Initiation Protocol, (SIP) invite message comprising a SDP Offer, a voice service session from a first party;
establishment of the voice service session in response to the SIP invite message so that voice traffic can flow through the dedicated network resources; and
association, to the first party, of a first partial duration of the voice service session that starts when the voice service session was initiated.

19. The apparatus according to claim 17 further to cause:
reception, when the voice service session is on hold or on temporary disconnect, of a signal for resuming of the voice service session from the party who invoked the hold or the temporary disconnect of the voice service session;
retrieval of the stored SDP offer from the internal storage; and
association, to the first party, of a second partial duration of the voice service session that starts when the voice service session was resumed.

20. The apparatus according to claim 17 further to cause:
release of the dedicated network resources of the voice service session in response to the storing of the SDP offer; and
re-assignment of the dedicated network resources for the voice service session in response to a retrieval of the stored SDP offer.

21-31. (cancelled)
